(19) United States
(12) Patent Application Publication
(10) Pub. No.: US 2008/0228551 A1
(43) Pub. Date: Sep. 18, 2008

(54) PERSONNEL ASSIGNMENT OPTIMIZATION PROGRAM, PERSONNEL ASSIGNMENT OPTIMIZATION METHOD, AND PERSONNEL ASSIGNMENT OPTIMIZATION DEVICE

(75) Inventor: Hideki YAMANAKA, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/041,192

(22) Filed: Mar. 3, 2008

(30) Foreign Application Priority Data
Mar. 15, 2007 (JP) 2007-67437

(51) Int. Cl. G06Q 10/00; G06F 17/10

(52) U.S. Cl. 705/9; 703/2

(57) ABSTRACT

An optimization control part controls as an optimum method that optimizes a personnel assignment with an optimum gradient method by simulating with a simulator. An increase and decrease personnel assignment calculation part calculates the increase and decrease personnel assignment by using an approximation model to find the next tentative optimum solution and to generate an initial value by using the approximation model. In addition, the personnel assignment information storage stores the necessary information to optimize the personnel assignment, and the simulator, the optimization control part and the increase and decrease personnel assignment calculation part refer to the information in the personnel assignment information storage part, update it and perform processing.

### CROSS-REFERENCE TO RELATED APPLICATIONS

This application is based upon and claims the benefit of priority to the prior Japanese Patent Application No. 2007-67437 filed on Mar. 15, 2007, the entire contents of which are incorporated herein by reference.

### BACKGROUND OF THE INVENTION

1. Field of the Invention

The present invention relates to a personnel assignment optimization program, a personnel assignment optimization method and a personnel assignment optimization device that repeatedly calculates the tentatively optimum tentative personnel assignment and optimizes the personnel assignment under the prescribed constrained condition concerning a prescribed index. The personnel assignment optimization program, the personnel assignment optimization method and the personnel assignment optimization device can calculate the optimum personnel assignment with high accuracy and high speed.

2. Description of the Related Art

personnel expenses account for a large percentage of the operating expense in a contact center. It is important to assign personnel optimally in such a contact center. Personnel assignment, for example, is optimized by using a mathematical model or a simulation in order to maximize the average utilization of personnel. The average utilization of the personnel is maximized in a range where prescribed indices such as the average abandoned call rate (average value of customers' abandoned contact rates) and customers' average waiting time meet prescribed constrained conditions.

Models such as Erlang A model, B model, and C model, which are based on the Queuing Theory, are used as mathematical models. In addition, optimization is performed in a simulation by calculating the performance indices. The performance indices are calculated by simulating the generation of contacts (calls) and agents' actions.

However, the accuracy of optimization using a mathematical model is not high because the mathematical model is an approximation model. On the other hand, a huge calculation time is required for optimization using a simulation because the personnel assignment problem is a combinatory optimization problem.

An object of this invention is to solve the above-mentioned problems of conventional art by providing a personnel assignment optimization program, a personnel assignment optimization method and a personnel assignment optimization device that can calculate the optimum personnel assignment with high accuracy and high speed.

### SUMMARY OF THE INVENTION

In a personnel assignment optimization program, tentatively optimum tentative personnel assignment is repeatedly calculated, and personnel assignment is optimized under constrained condition concerning prescribed index; a simulation execution procedure calculates a performance index by executing simulation to the tentative personnel assignment, an increase and decrease personnel assignment calculation procedure calculates the increase and decrease personnel assignment to the tentative personnel assignment using the performance index calculated by the simulation execution procedure and an approximation model, and a tentative personnel assignment update procedure updates the tentative personnel assignment by using the increase and decrease personnel assignment calculated by the increase and decrease personnel assignment procedure. The personnel assignment optimization program is executed repeatedly by a computer until the increase and decrease personnel assignment meets the prescribed convergence condition.

The above-described embodiments of the present invention are intended as examples, and all embodiments of the present invention are not limited to including the features described above.

### BRIEF DESCRIPTION OF THE DRAWINGS

FIG. 1 is an explanatory drawing that explains the personnel assignment in the contact center;

FIG. 2 is a functional block diagram that shows the configuration of the personnel assignment optimization device of this embodiment;

FIG. 3 shows one example of the personnel assignment data;

FIG. 4 shows one example of the task combination data;

FIG. 5 shows one example of the shift data;

FIG. 6 shows one example of the shift configuration data;

FIG. 7 shows one example of the line configuration data;

FIG. 8 shows one example of the number of contacts data;

FIG. 9 shows one example of the parameter data;

FIG. 10 shows one example of the restriction value and the optimization target;

FIG. 11 shows one example of the performance indices;

FIG. 12 is an explanatory drawing to explain the simulator;

FIG. 13A is a figure (1) that shows one example of the simulation result by the simulator;

FIG. 13B is a figure (2) that shows one example of the simulation result by the simulator;

FIG. 14 is an explanatory drawing to explain the optimal gradient method that the optimization control part uses to optimize the personnel assignment;

FIG. 15 is an explanatory drawing to explain the calculation method of the increase and decrease personnel assignment by the increase and decrease personnel assignment calculation part;

FIG. 16 is a flow chart that shows the processing procedure of the personnel assignment optimization processing by the personnel assignment optimization device of this embodiment;

FIG. 17 is a flow chart that shows the processing procedure of the initial value generation processing by the initial value generation part;

FIG. 18 is a functional block diagram that shows the configuration of the computer that executes the personnel assignment optimization program of this embodiment.

### DETAILED DESCRIPTION OF THE PREFERRED EMBODIMENTS

Reference may now be made in detail to embodiments of the present invention, examples of which are illustrated in the accompanying drawings, wherein like reference numerals refer to like elements throughout.

Referring to the attached drawing, preferred embodiments of the personnel assignment optimization program, the personnel assignment optimization method and the personnel assignment optimization device of this invention are explained in details as below. In addition, in these embodiments, the case when this invention was applied to optimize the personnel assignment of the contact center is mainly explained.

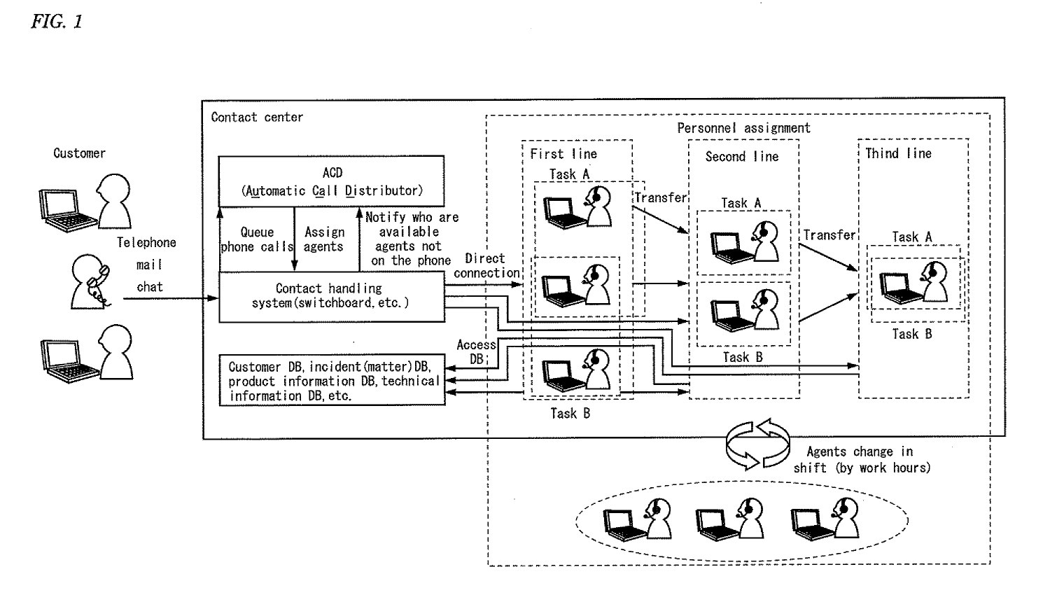

First of all, the personnel assignment in the contact center, that is, the arrangement of agents is explained. FIG. 1 is an explanatory drawing to explain the personnel assignment in the contact center. As shown in the figure, agents are allocated to two or more lines in the contact center.

Here, a line means a layer of agents assigned hierarchically. In FIG. 1, agents are assigned to the first line, the second line and the third line. Agents in each line handle the contacts from the customers by referring to a customer database (DB), incident DB, product information DB, and technical information DB.

Contacts from the customers comprising telephone calls, mails and chats are received at the contact processor and passed to ACD (Automatic Call Distributor). The ACD assigns them to the agents in the first line. Then, the contacts that the agents in the first line cannot handle are assigned to the agents in the second line, and the contacts that the agents in the second line cannot handle are assigned to the agents in the third line.

Agents in each line need to handle plural tasks. If one agent is in charge of “Task A” and another agent is in charge of “Task B,” it is necessary to assign agents to plural tasks. In addition, there are plural shifts (working hours) in the contact center.

As a result, it is necessary to determine how many agents to assign to each task in each line and in each shift during personnel assignment in the contact center. To determine the number of agents, it is necessary to perform optimization so as to meet the target index such as maximizing the average utilization of agents within the range where indices such as average abandoned call rate, average waiting time, the number of agents meet the prescribed constrained conditions.

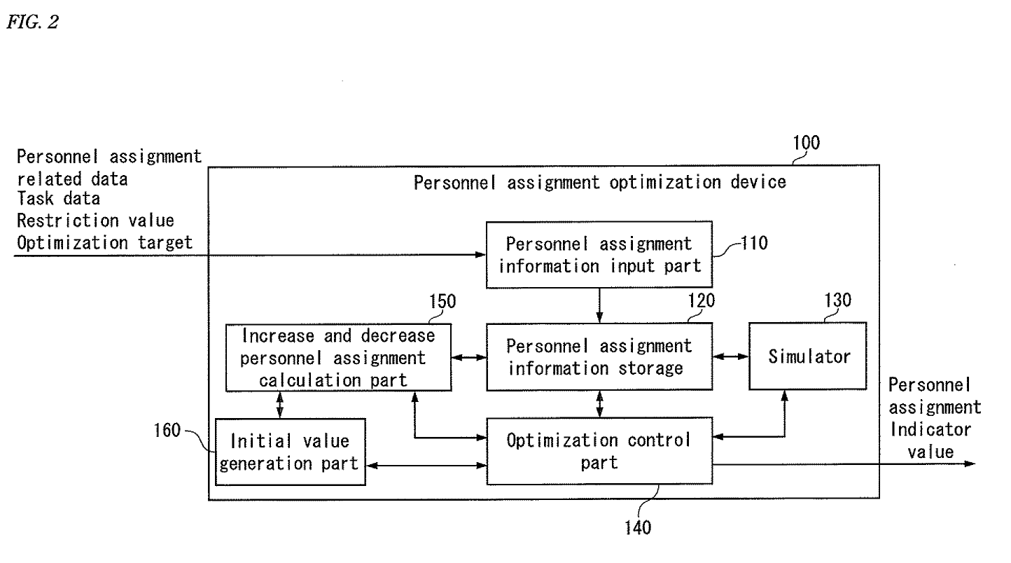

Next, the configuration of the personnel assignment optimization device of this embodiment is explained. FIG. 2 is a functional block diagram that shows the configuration of the personnel assignment optimization device of this embodiment. As shown in the figure, this personnel assignment optimization device 100 comprises a personnel assignment information input part 110, a personnel assignment information storage 120, a simulator 130, an optimization control part 140, an increase and decrease personnel assignment calculation part 150, and an initial value generation part 160.

The personnel assignment information input part 110 is a processing part where information necessary for the personnel assignment optimization such as personnel assignment-related data, business data, restriction value, and it writes the input information in the personnel assignment information storage 120.

Here, data related to the personnel assignment is data that relates to the personnel assignment, and it comprises personnel assignment data that shows personnel assignment, task combination data that shows the combination of tasks, shift data that show shifts, shift configuration data that shows the correspondence between shifts and tasks, line configuration data that shows the correspondence between lines, tasks and skill levels.

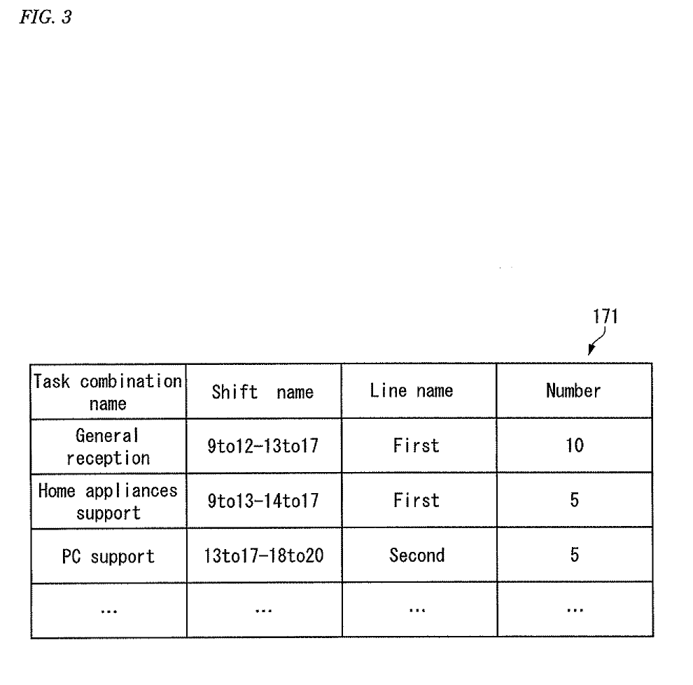

FIG. 3 shows one example of the personnel assignment data. As the figure shows, the personnel assignment data 171 is data in which the combination of task combination names, shift names and line names is corresponded to the number of agents. For example, in FIG. 3, “10” agents are assigned to a task combination name “general reception”, a shift name “9 to 12-13 to 17”, and a line name “first.” In addition, the task combination means the combination of plural tasks and each agent is in charge of not one task but the combination of tasks, that is, plural tasks. Further, when the personnel assignment information input part 110 inputs the personnel assignment data, the number of people is “0,” and the number of people becomes an optimum value as optimization processing advances.

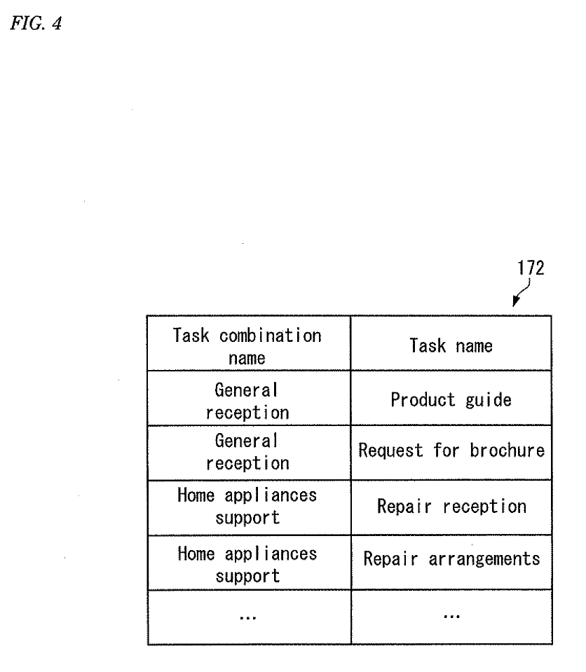

FIG. 4 shows one example of the task combination data. As shown in the figure, the task combination data 172 is data in which the task combination names and the tasks are corresponded. For example, in FIG. 4, a task combination name “General reception” corresponds to task names such as “Product guide” and “Request for brochure.”

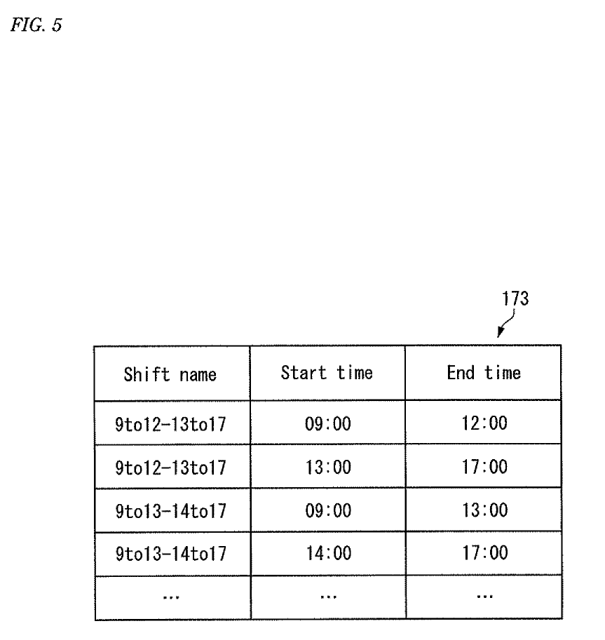

FIG. 5 shows one example of the shift data. As shown in the figure, this shift data 173 is data in which the shift names, the shift start times and the shift end times are corresponded. For example, in FIG. 5, start times “9:00” and “13:00” and end times “12:00” and “17:00” are corresponded to a shift name “9 to 12-13 to 17.” That is, the work hours of a shift whose shift name is “9 to 12-13 to 17” are 9 to 12 and 13 to 17, and break time is 12 to 13.

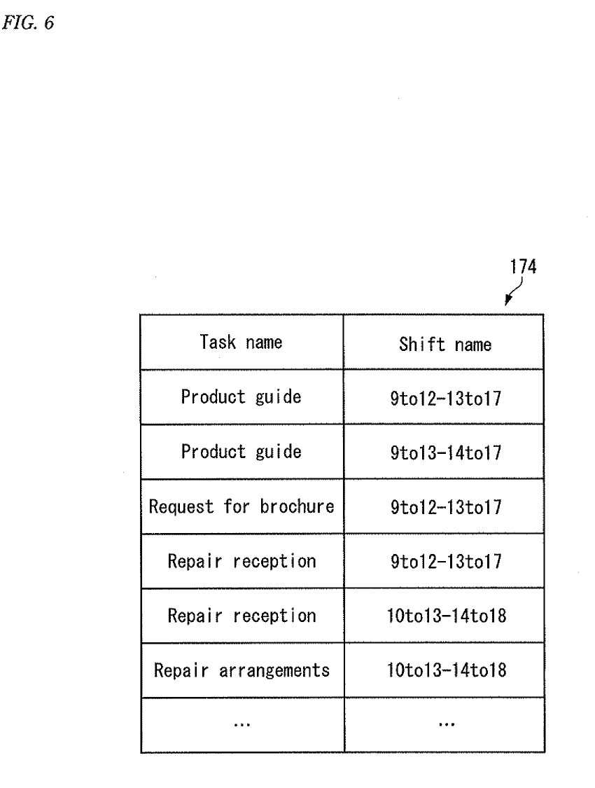

FIG. 6 shows one example of the shift configuration data. As shown in the figure, the shift configuration data 174 is data in which the task names and the shift names are corresponded. For example, in FIG. 6, a task whose task name is “Product guide” is one task performed in the shift whose shift name is “9 to 12-13 to 17” or “9 to 13-14 to 17.”

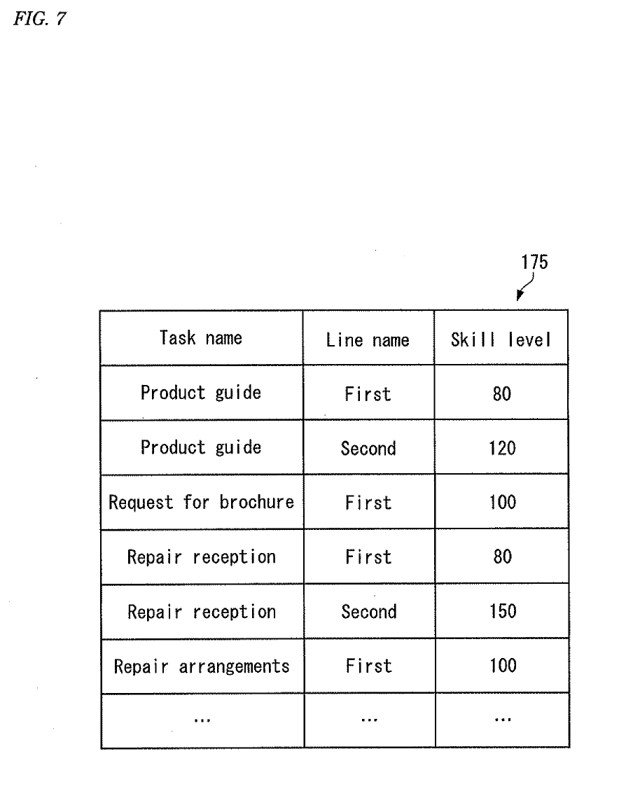

FIG. 7 shows one example of the line configuration data. As shown in the figure, the line configuration data 175 is data in which the task names, the line names and the skill levels are corresponded. For example, in FIG. 7, tasks in the line whose line name is “first” are such as “Product guide,” “Request for brochure,” and “Repair arrangements,” and their required skills are “Product guide” which is “80,” “Request for brochure” which is “100,’ and “Repair arrangements” which is “100.”

The task data is data related to tasks and comprises the number of contacts data that shows the number of contacts from customers and parameter data that shows parameters related to the tasks.

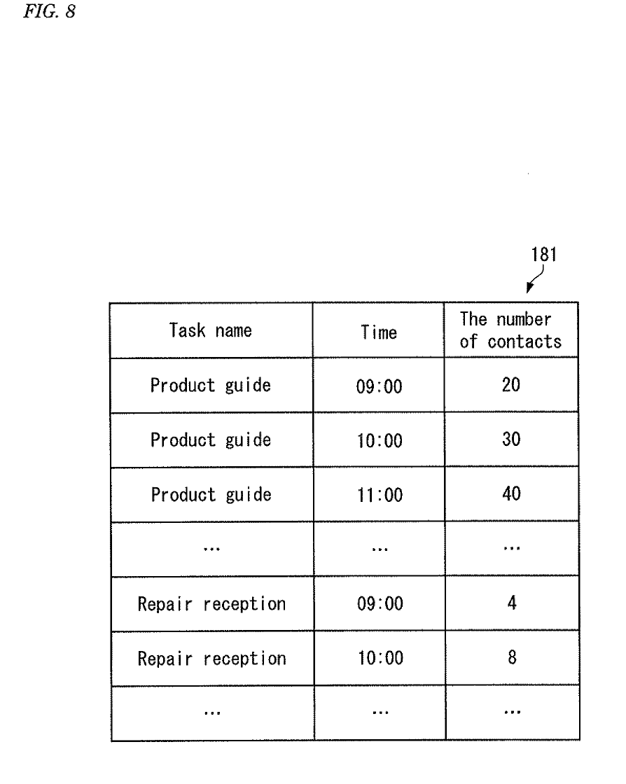

FIG. 8 shows one example of the number of contact data. As shown in the figure, the number of contact data 181 is data in which the task names, time and the number of contacts are corresponded. For example, in FIG. 8, as for the task whose task name is “Product guide,” the number of contacts at time “09:00 is “20,” the number of contacts at time “10:00” is “30,” and the number of contacts at time “11:00” is “40.”

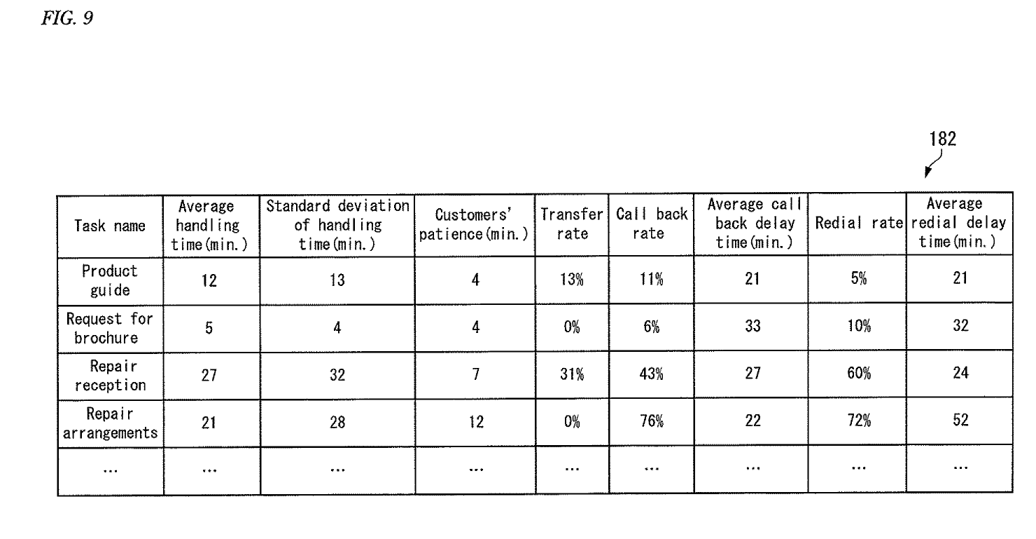

FIG. 9 shows one example of the parameter data. As shown in the figure, this parameter data 182 is data in which task names, average handling time, standard deviation of handling time, customers' patience, transfer rate, call back rate, average call back delay time, redial rate and average redial delay time are corresponded per task.

Here, customer's patience means average time that the customer will not cancel the call by the time when it is connected to the agent and will wait in the queue, and the transfer rate is a rate from which the handling change is performed from the agent in the line “first” to the agent in the line “second.” In addition, the call back rate is a rate in which the agent hangs up the telephone once and calls back again. The average call back delay time is time from when the agent hangs up the telephone to when the agent calls back. Further, the redial rate is a rate that the customer who hung up the telephone before it was connected to the agent, calls again, and the average redial delay time is average time until the customer calls again.

For example, in FIG. 9, as for the task whose task name is “Product guide,” the average handling time is 12 minutes, the standard deviation of handling time is 13 minutes, the customer's patience is 4 minutes, the transfer rate is 13%, the call back rate is 11%, the average call back delay time is 21 minutes, the redial rate is 5%, and the average redial delay time is 21 minutes.

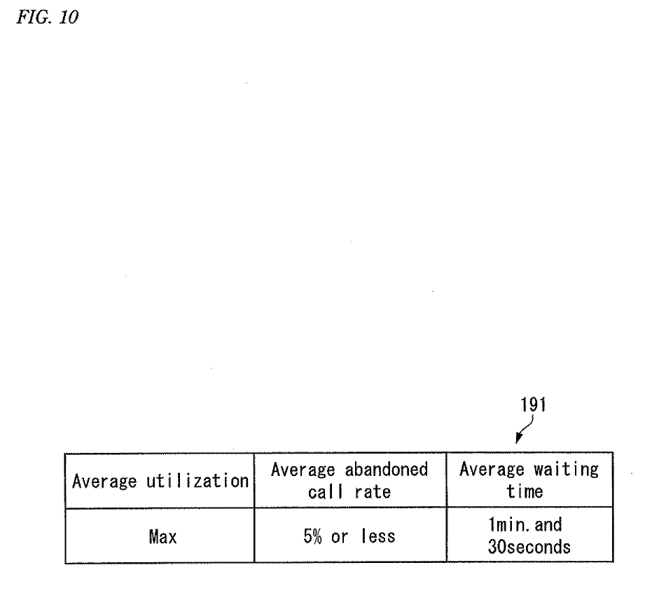

The restriction value is a value that the index should meet as a constrained condition, here, the value of the average abandoned call rate and the average waiting time are assumed to be the restriction value. The optimization target is a target of optimization within the range to meet the constrained condition. FIG. 10 shows one example of the restriction value and the optimization target. As for the restriction values and the optimization target 191 shown in the figure, the optimization target is to maximize the average utilization of the agents under the constrained condition in which the average abandoned call rate is 5% or less and the average waiting time is 1 minutes and 30 seconds or less.

Returning to FIG. 2, the personnel assignment information storage 120 is a storage part where necessary information to optimize the personnel assignment such as information input by the personnel assignment information input part 110 is stored. Concretely, this personnel assignment information storage 120 stores such as the personnel assignment related data input by the personnel assignment information input part 110, the task data, the restriction values, the optimization target, the performance index and the increase and decrease personnel assignment.

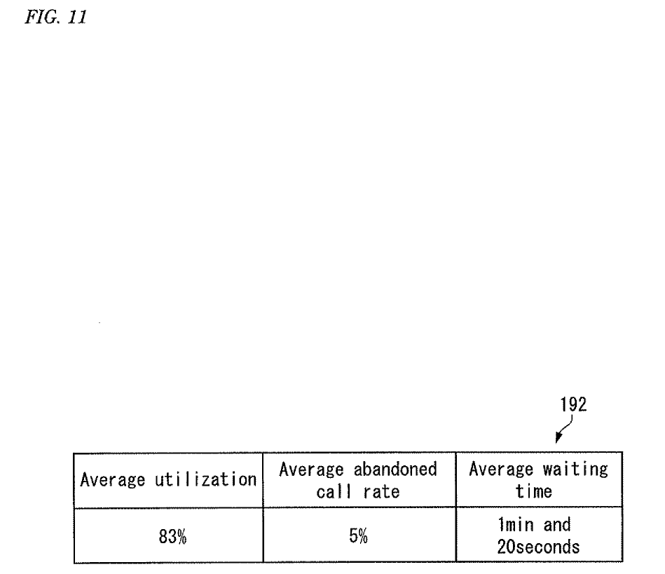

FIG. 11 shows one example of the performance indices. As for the performance index 192 shown in this figure, the average utilization of the agents in some personnel assignment is 83%, the average abandoned call rate is 5% and the average waiting time is 1 minute and 20 seconds. In addition, the increase and decrease personnel assignment is described below.

The simulator 130 is a device that simulates the contact processing in the contact center by using the personnel assignment related data and the task data store in the personnel assignment information storage 120, based on the instruction from the optimization control part 140, calculates the performance indices by a simulation and stores them in the personnel assignment information storage 120.

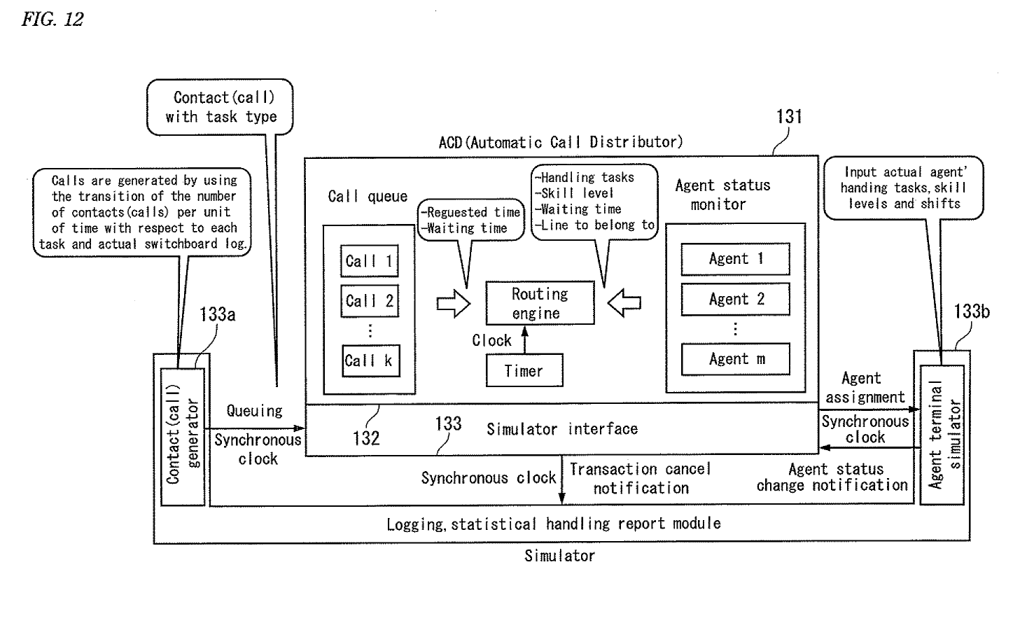

FIG. 12 is an explanatory drawing to explain the simulator 130. As shown in the figure, the simulator 130 comprises ACD131, a simulator interface 132, logging, statistical processing, and report module 133.

ACD131 is a device that assigns the contacts generated by logging, statistical processing and the report module 133, to the agents. The simulator interface 132 is an interface that connects the ACD 131, logging, statistical processing, and the report module 133.

Logging, statistical processing, and the report module 133 are the main body of the simulator that performs such as generation of contacts, simulation of terminals operated by the agents, logging of a simulation execution state, statistical processing of log data, calculation of the performance indices and creation of the reports, and it comprises a contact generator 133a that generates contacts and the agent terminal simulator 133b that simulates the agent terminals.

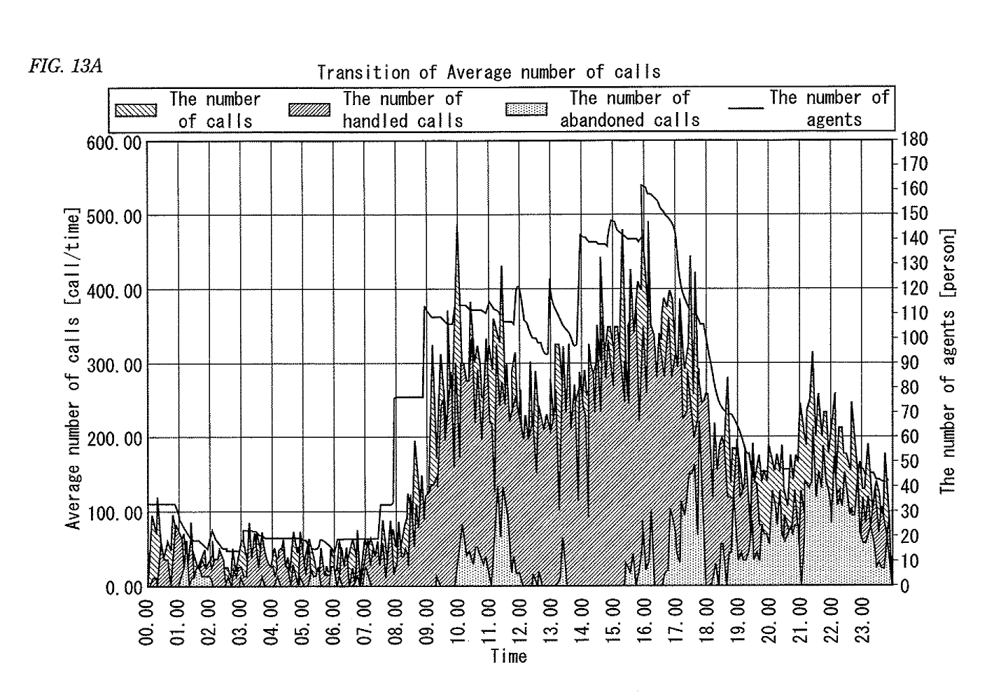

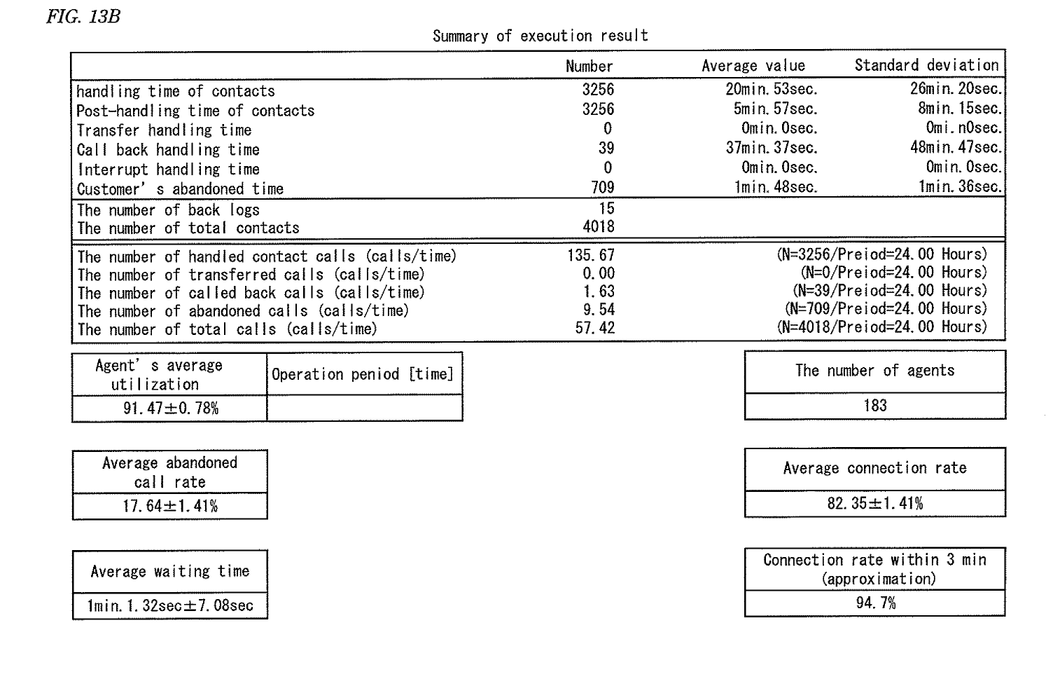

FIG. 13A and FIG. 13B are figures that show one example of a simulation result by the simulator 130. FIG. 13A shows the time transition of the number of calls, the number of call processing, the number of abandoned calls, and the number of agents. FIG. 13B shows the summary of the simulation execution result. As shown in FIG. 13B, simulation calculates the performance indices such as the agents average utilization, the average abandoned call rate, and the average waiting time.

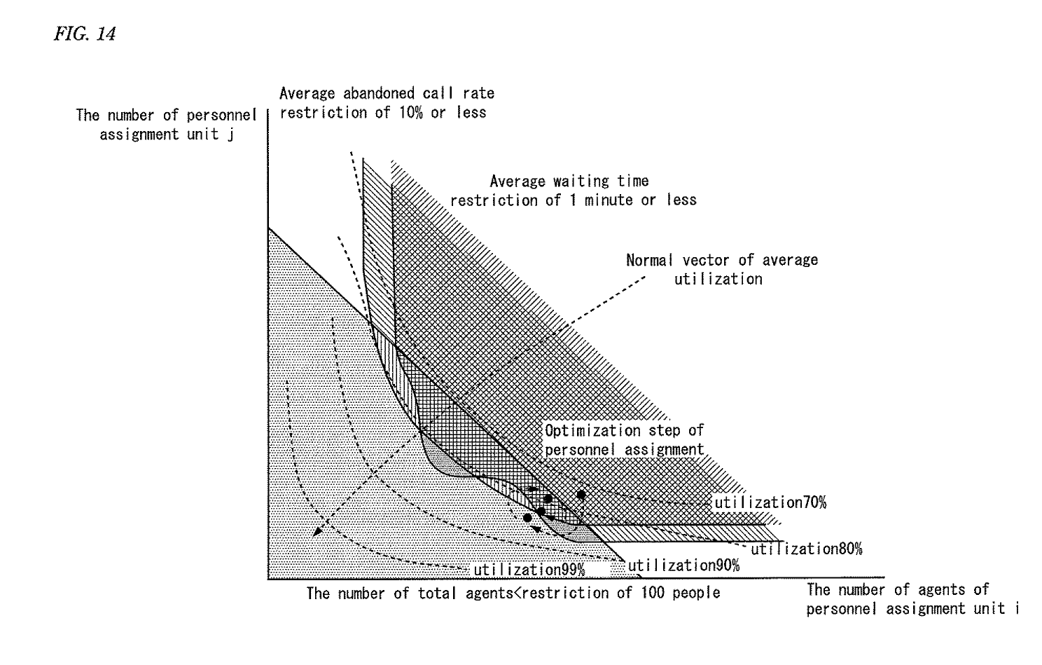

The optimization control part 140 is a control part that controls optimization of the personnel assignment with the optimum gradient method by simulating with the simulator 130. FIG. 14 is an explanatory drawing to explain the optimum gradient method that the optimization control part 140 uses to optimize the personnel assignment. This figure indicates the case when the average utilization is maximized under the constrained condition in which the average abandoned call rate is 10% or less, the average waiting time is 1 minute or less and the number of total agents is 100 or less.

In the optimum gradient method, an optimum solution is searched from the initial solution by using what the (local) optimum solution exists in the edge of the area that shows the constrained condition. In FIG. 14, the optimum solution exists in the intersection point between the curve that shows the average abandoned call rate is 10% and the curve that shows the average waiting time is 1 minute. In addition, in FIG. 14, a two-dimensional plane is used for easier explanation, though generally the optimum solution exists in the edge corresponding to the restriction value of the performance indices in n-dimension space.

In addition, though the personnel assignment problem is a combination optimization problem, due to the characteristics of a contact center,

A simulation can be almost regarded as a function

It is a non-linear optimization problem with restrictions in the almost convex (no-mountain) integer area, it is possible to reduce the problem to the real number area, locally optimize with the optimum gradient method, and converge to an almost globally optimum solution even from a inaccurate initial solution.

In a normal simulation that does not use the optimal gradient method, it takes 3 or more operations for optimization in units of each personnel assignment (unit to assign personnel by combination of tasks, shifts and lines). Even in the case of small-sized contact center (3 tasks, 2 shifts, and 2 lines), it takes (2³−1)×2×2×3=84 operations for an entire optimization. In addition, calculation time for one operation (time to find from a tentative optimum solution to the next tentative optimum solution) becomes (time for simulation once)×(the number of task combination)×(the number of shifts)×(the number of lines)×2. Here, the reason to double at last is that it is necessary to search two cases in which one agent is increased or one agent is decreased.

As a result, if a calculation time of a simulation once is assumed to be 2 minutes, the calculation time for one operation becomes 2 minutes×(2³−1)×2×2×2=112, and 112 minutes×84=9408 minutes or more is needed for optimization. On the other hand, because the optimization control part 140 uses the optimal gradient method, the number of operations can be decreased and necessary time for optimization can be decreased dramatically.

The increase and decrease personnel assignment calculation part 150 is a processing part to calculate the increase and decrease personnel assignment for the optimization control part 140 to find the next tentative optimum solution, and it stores the calculated increase and decrease personnel assignment in the personnel assignment information storage 120. Here, the increase and decrease personnel assignment means the number of increased or decrease agents in units of personnel assignment. The optimum control part 140 finds the next personnel assignment, that is, the next tentative optimum solution, and updates the personnel assignment data in the personnel assignment information storage 120.

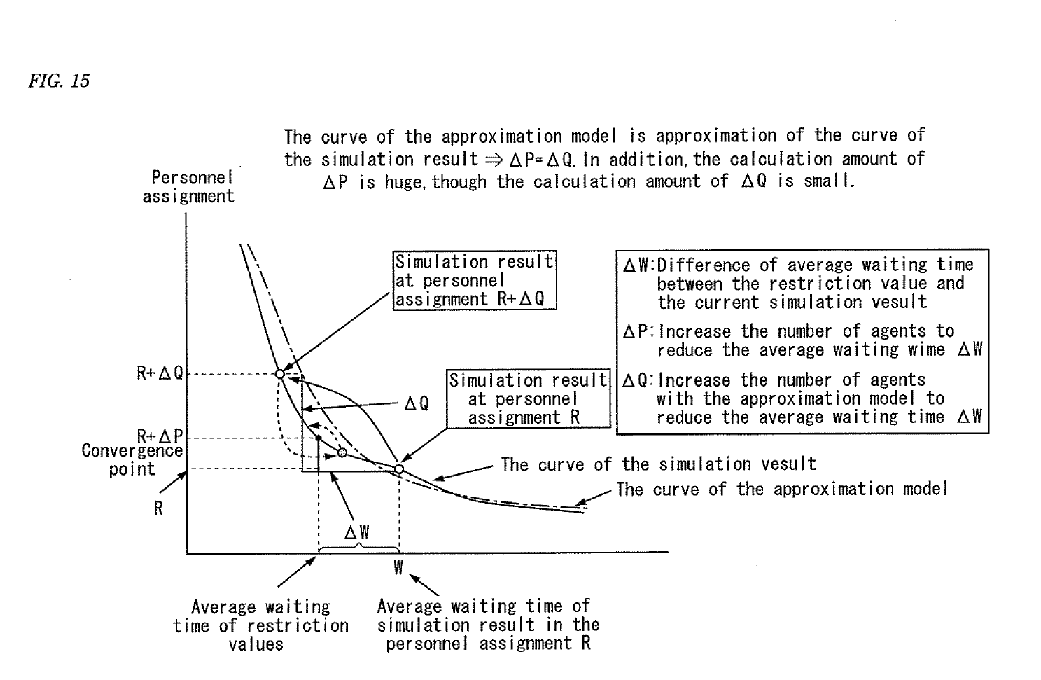

FIG. 15 is an explanatory drawing to explain the calculation method of the increase and decrease personnel assignment by the increase and decrease personnel assignment calculation part 150. In addition, this figure shows the average waiting time and the constrained condition. As shown in the figure, the increase and decrease personnel assignment calculation part 150 calculates the increase and decrease personnel assignment by using the approximation model (mathematical model such as the Erlang model) instead of a simulation. That is, if it is assumed that the average waiting time for the simulation to personnel assignment R is W, the difference between W and the restriction time of the average waiting time is ΔW, the increase and decrease personnel assignment at a simulation to decrease the average waiting time ΔW is ΔP, the increase and decrease assignment in the approximation model to decrease the average waiting time ΔW is ΔQ, the increase and decrease personnel assignment calculation part 150 is calculated by assuming ΔQ as the increase and decrease personnel assignment instead of ΔP.

Here, because the simulation result in W and the inclination of the approximation model are almost equal, ΔQ is almost equal to ΔP, and the calculation amount of ΔQ is far less than the calculation amount of ΔP. As a result, the increase and decrease personnel assignment calculation part 150 can calculate the increase and decrease personnel assignment with high speed.

Concretely, the increase and decrease personnel assignment calculation part 150 can decrease the calculation time for one operation (here, it is not the increase and decrease of one person, but the increase and decrease by inclination) from (calculation time for simulation once)×(the number of neighborhood) to (calculation time for simulation once)+(calculation time of inclination in the approximation model)×(the number of neighborhood). Here, the number of neighborhood (personnel assignment unit)=(the number of task combinations)×(the number of shifts)×(the number lines)=the dimension of the inclination vector, and (calculation time of inclination in the approximation model)×(the number of neighborhood) is time that can be ignored if it is compared with (calculation time for simulation once).

Thus, time necessary for optimization can be decreased dramatically by the increase and decrease personnel assignment calculation part 150 not using a simulation but using the approximation mode to calculate the increase and decrease personnel assignment.

The initial value generation part 160 is a processing part that generates the initial value used by the optimum control part 140 for optimization. This initial value generation part 160 generates the initial value by using the approximation model. Because the initial value generation part 160 generates the initial part by using the approximation mode, the appropriate initial value around globally optimum value can be generated with high speed.

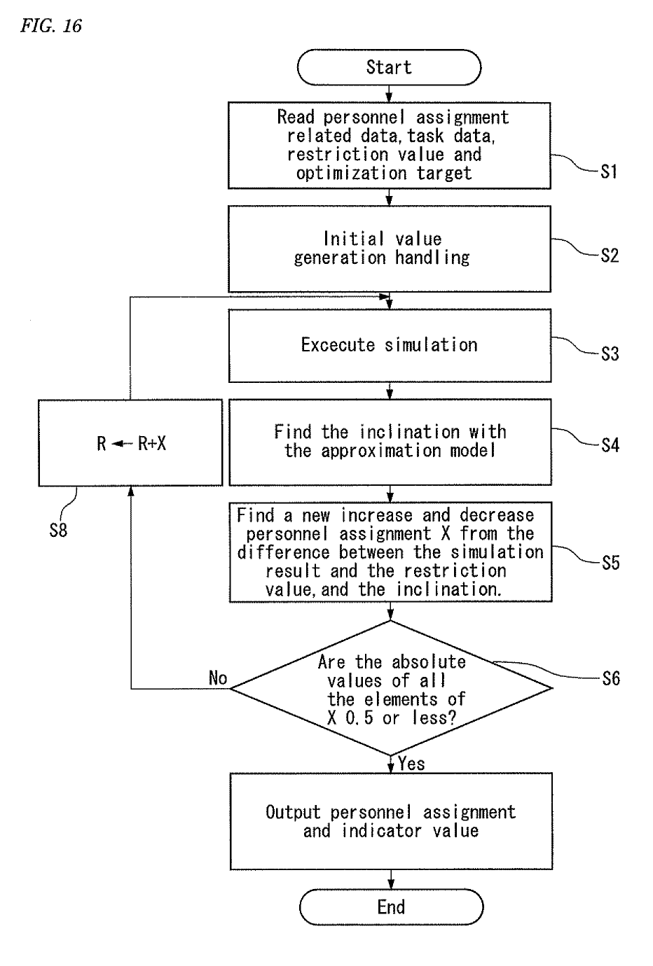

Next, the processing procedure of the personnel assignment optimization processing by the personnel assignment optimization device 100 of this embodiment is explained. FIG. 16 is a flow chart that shows the processing procedure of the personnel assignment optimization processing by the personnel assignment optimization device 100 of this embodiment.

As shown in this figure, in this personnel assignment optimization device 100, the personnel assignment information input part 110 reads the personnel assignment related data, the task data, the restriction values and the optimization target and stores them in the personnel assignment information storage 120 (Operation S1).

Then, the initial value generation part 160 performs the initial value generation processing that generates the initial value (Operation 2), and the optimization control part 140 instructs a simulation to the simulator 130 with the initial value as the tentative optimum personnel assignment. Then, the simulator 130 performs a simulation by referring to the personnel assignment information storage 120 (Operation S3), and stores the performance index in the personnel assignment information storage 120.

Then, the increase and decrease personnel assignment calculation part 150 calculates the inclination by using the approximation model (Operation S4), and calculates the increase and decrease personnel assignment X from the difference between the simulation result and the restriction value and the inclination, and stores it in the personnel assignment information storage 120 (Operation S5).

Then, the optimization control part 140 refers to increase and decrease personnel assignment X in the personnel assignment information storage 120, and determines whether the absolute values of all elements of the increase and decrease personnel assignment X are 0.5 people or less (Operation S6). As a result, if the absolute values of all elements are 0.5 people or less, the optimization control part 140 judges that optimum solution is obtained and outputs the personnel assignment and the performance indices by referring to the personnel assignment data and the performance indices in the personnel assignment information storage 120 (Operation S7). On the other hand, if the absolute values of not all elements are 0.5 people or less, the optimization control part 140 adds the increase and decrease personnel assignment X to the current personnel assignment R and updates the personnel assignment information storage 120 (Operation S8), then returns to Operation S3.

Thus, because the increase and decrease personnel assignment part 150 calculates the increase and decrease personnel assignment X by using the approximation model, the next tentative personnel assignment can be calculated with high speed.

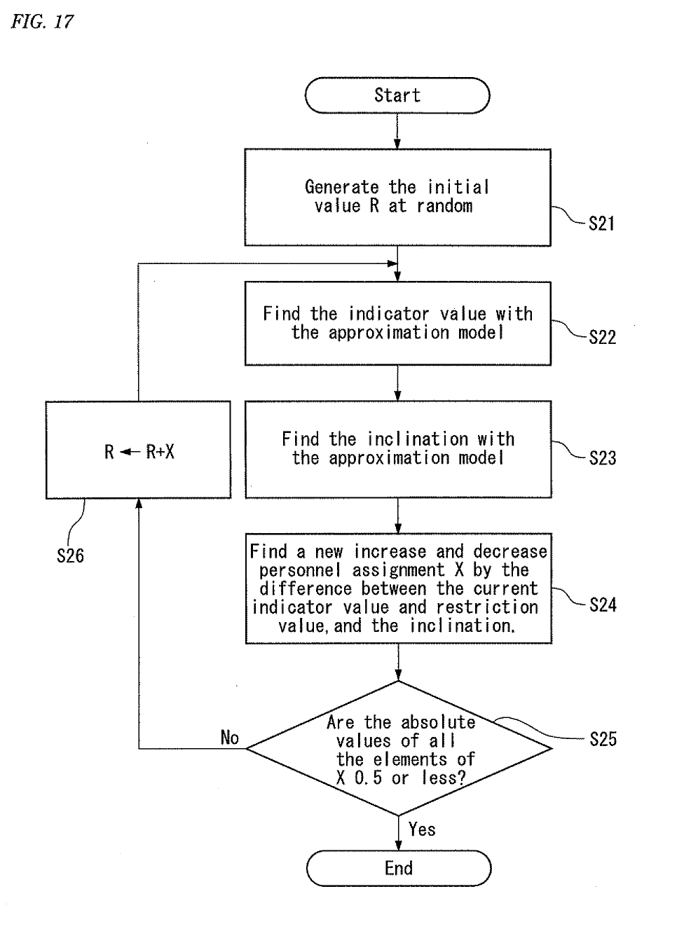

Next, the processing procedure of the initial value generation processing by the initial value generation part 160 is explained. FIG. 17 is a flow chart that shows the processing procedure of the initial value generation processing by the initial value generation part 160. The initial value generation processing by this initial value generation part 160 corresponds to the processing of Operation S2 shown in FIG. 16.

As shown in FIG. 17, in this initial value generation processing, the initial value generation part 160 generates the initial value R at random and stores it in the personnel assignment information storage 120 (Operation S21). Then, the performance index corresponding to R is calculated by using the approximation model (Operation S22), and the calculated performance index is stored in the personnel assignment information storage 120.

Then, when the increase and decrease personnel assignment calculation part 150 is instructed to calculate the increase and decrease personnel assignment, the increase and decrease personnel assignment calculation part 150 calculates the inclination by using the approximation model (Operation S23), then calculates the increase and decrease personnel assignment X from the difference between the calculated performance index and the restriction value calculated in operation S22 and the inclination, and stores it in the personnel assignment information storage 120 (Operation S24).

Then, the initial value generation part 160 refers to the increase and decrease personnel assignment X in the personnel assignment information storage 120, and determines whether the absolute values of all elements of the increase and decrease personnel assignment X are 0.5 people or less (Operation S25). As a result, if the absolute values of all the elements are 0.5 or less, the initial value generation part 160 ends processing with the current personnel assignment R as the initial value, and if the absolute values of not all the elements are 0.5 or less, the initial value generation part 160 updates the personnel assignment information storage 120 by adding the increase and decrease personnel assignment X to the current personnel assignment R (Operation S26), then it returns to Operation S22.

Thus, by the initial value generation part 160's instructing the increase and decrease personnel assignment calculation part 150 to calculate the increase and decrease personnel assignment X, an appropriate initial value that uses the approximate value model can be generated.

As mentioned above, because in this embodiment, the optimization control part 140 controls as the personnel assignment is optimized by simulating by using the simulator 130 with the optimum gradient method, and the increase and decrease personnel assignment calculation part 150 calculates the increase and decrease personnel assignment by using the approximation model for the optimization control part 140 to find the next tentative optimum solution, the optimum personnel assignment can be calculated with high accuracy and high speed. In addition, because in this embodiment, the initial value generation part 160 generates the initial value by using the approximation mode, an appropriate initial value can be calculated with high speed. In addition, the personnel assignment information storage 120 stores the necessary information to optimize the personnel assignment, and the simulator 130, the optimization control part 140 and the increase and decrease personnel assignment calculation part 150 refer to the information in the personnel assignment information storage part 120, update it and perform processing.

In addition, though the personnel assignment optimization device is explained in this embodiment, by realizing the configuration comprised by the personnel assignment optimization device by software, a personnel assignment optimization program comprising the similar function can be acquired. So, the computer that executes this personnel assignment optimization program is explained.

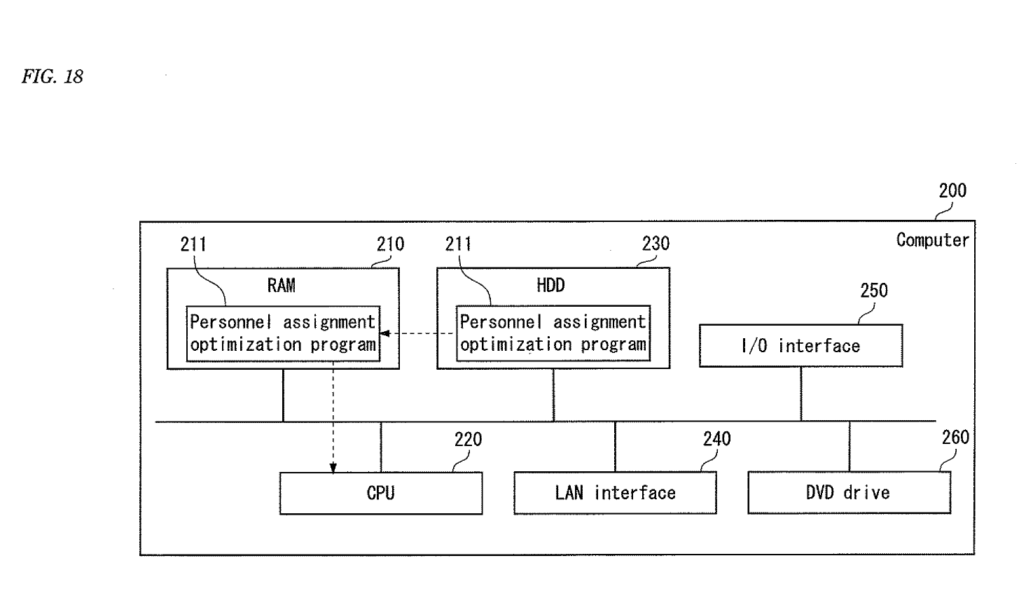

FIG. 18 is a functional block diagram that shows the configuration of the computer that executes the personnel assignment optimization program of this embodiment. As shown in this figure, this computer 200 comprises RAM 210, CPU 220, HDD 230, LAN interface 240, I/O interface 250, and DVD drive 260.

RAM 210 is a memory that stores a program or a program execution result halfway through processing. CPU 220 is a central processing unit that reads a program from RAM 210 and executes it. HDD 230 is a disk device that stores a program or data. LAN interface 240 is an interface that connects computer 200 with another computer via LAN. I/O interface 250 is an interface that connects input devices such as a mouse and a keyboard and display devices. DVD drive 260 is a device that reads and writes a DVD.

Then, the personnel assignment optimization program 211 executed in this computer 200 is stored in a DVD, and it is read from the DVD by the DVD drive 260, and installed in the computer 200. Or, this personnel assignment optimization program 211 is stored in such as data bases of other computer systems connected via LAN interface 240. The program is read from these data bases and is installed in the computer 200. Then, the installed personnel assignment optimization program 211 is stored in HDD 230, read by RAM 210 and executed by CPU 220.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A computer readable medium string a personnel assignment optimization program, that is tentatively optimal tentative personnel assignment is repeatedly calculated, and personnel assignment is optimized under constrained condition concerning prescribed index, comprising:
a simulation execution procedure that calculates a performance index by executing simulation to the tentative personnel assignment;
an increase and decrease personnel assignment calculation procedure that calculates the increase decrease personnel assignment to the tentative personnel assignment using the performance index calculated by the simulation execution procedure and an approximation model; and
a tentative personnel assignment update procedure that updates the tentative personnel assignment by using the increase and decrease personnel assignment calculated by the increase and decrease personnel assignment procedure, are repeatedly executed by a computer until the increase and decrease personnel assignment meets the prescribed convergence condition.

2. The computer readable medium according to claim 1, wherein:
the increase and decrease personnel assignment calculation procedure calculates the increase and decrease personnel assignment possible within the range where the performance index meets the constrained condition by using inclination of the approximation model, and regards the calculated increase and decrease personnel assignment as the increase and decrease personnel assignment to the tentative personnel assignment.

3. The computer readable medium according to claim 1, further comprising:
the computer is further made execute an initial personnel assignment calculation procedure that repeatedly calculates tentative initial personnel assignment from arbitrary personnel assignment and calculates the tentative personnel assignment used as initial solution by the simulation execution procedure.

4. The computer readable medium according to claim 3, wherein:
the initial personnel assignment calculation procedure that makes the computer repeatedly execute a performance index calculation procedure that calculates the performance index by using the approximation model for the tentative initial personnel assignment, an increase and decrease personnel assignment calculation procedure for initial solution that calculates the increase and decrease personnel assignment for initial solution to the tentative initial personnel assignment by using the performance index calculation procedure, and a tentative personnel assignment update procedure for initial solution that updates the tentative initial personnel assignment by using the increase and decrease personnel assignment for initial solution calculated by the increase and decrease personnel assignment calculation procedure for initial solution, until the increase and decrease personnel assignment for initial solution meets a prescribed convergence condition.

5. The computer readable medium according to claim 1, wherein:
the approximation model is based on the Erlang model.

6. A personnel assignment optimization method by a personnel assignment optimization device, wherein:
the personnel assignment optimization device repeatedly calculates tentatively optimal tentative personnel assignment and optimizes the personnel assignment under a constrained condition concerning a prescribed index, comprising:
calculating the performance index by executing a simulation to the tentative personnel assignment;
calculating the increase and decrease personnel assignment to the tentative personnel assignment by using the performance index and the approximation model;
updating the tentative personnel assignment by using the increase and decrease personnel assignment, and:
repeating the simulation execution, the increase and decrease personnel assignment calculation, and the tentative personnel assignment update until the increase and decrease personnel assignment meets the prescribed convergence condition.

7. The personnel assignment optimization method according to claim 6, wherein:
the increase and decrease personnel assignment calculation calculates the increase and decrease personnel assignment possible within the range where the performance index meets the constrained condition by using inclination of the approximation model, and regards the calculated increase and decrease personnel assignment as the increase and decrease personnel assignment to the tentative personnel assignment.

8. The personnel assignment optimization method according to claim 6, further comprising:
calculating tentative initial personnel assignment from arbitrary personnel assignment repeatedly; and
calculating the tentative personnel assignment used as initial solution b repeatedly.

9. The personnel assignment optimization method according to claim 8, wherein:
the initial personnel assignment calculation comprises the index calculation that calculates the performance index to the tentative initial personnel assignment by using the approximation model, the increase and decrease personnel assignment calculation for initial solution that calculates the increase and decrease personnel assignment for initial solution to the tentative initial personnel assignment by using the performance indices calculated in the performance index calculation and the approximation model, and the tentative personnel assignment update for initial solution that updates the tentative initial personnel assignment by using the increase and decrease personnel assignment for initial solution calculated in the increase and decrease personnel assignment calculation for initial solution, wherein:
the performance index calculation, the increase and decrease personnel assignment calculation for initial solution and the tentative personnel assignment update for initial solution are repeated until the increase and decrease personnel assignment for initial solution meets the prescribed convergence condition.

10. The personnel assignment optimization method according to claims 6, wherein:
the approximation model is based on the Erlang model.

11. A personnel assignment optimization apparatus, wherein:
tentatively optimal tentative personnel assignment is repeatedly calculated, and personnel assignment is optimized under a constrained condition concerning a prescribed index; the personnel assignment optimization device comprising:
a simulation execution method that calculates a performance index by executing simulation to the tentative personnel assignment;
a increase and decrease personnel assignment calculation method that calculates the increase and decrease personnel assignment to the tentative personnel assignment by using the performance index calculated by the simulation execution method and an approximation model;
a tentative personnel assignment update method that updates the tentative personnel assignment by using the increase and decrease personnel assignment calculated by the increase and decrease personnel assignment method, and the personnel assignment optimization device repeatedly operates until the simulation execution method; and
a increase and decrease personnel assignment calculation method, and the tentative personnel assignment update method repeatedly meet the prescribed convergence condition.

12. The personnel assignment optimization apparatus according to claim 11, wherein:
the increase and decrease personnel assignment calculation procedure calculates the increase and decrease personnel assignment possible within the range where the performance index meets the constrained condition by using inclination of the approximation model, and regards the calculated increase and decrease personnel assignment as the increase and decrease personnel assignment to the tentative personnel assignment.

13. The personnel assignment optimization apparatus according to 11, wherein: it further comprises an initial personnel assignment calculation method that repeatedly calculates tentative initial personnel assignment from arbitrary personnel assignment and calculates the tentative personnel assignment used as initial solution by the simulation execution method.

14. The personnel assignment optimization apparatus according to claim 13, wherein:
the initial personnel assignment calculation method comprises the performance index calculation method that calculates the performance indices to the tentative personnel assignment by using the approximation model, the increase and decrease personnel assignment calculation method for initial solution that calculates the increase and decrease personnel assignment for initial solution to the tentative initial personal assignment by using the performance indices calculated by the performance index calculation method and the approximation model, and the tentative personnel assignment update method that updates the tentative initial personnel assignment by using the increase and decrease personnel assignment for initial solution calculated by the increase and decrease personnel assignment calculation method for initial solution, and the performance index calculation method, the increase and decrease personnel assignment calculation method for initial solution and the tentative personnel assignment update method for initial solution repeatedly operate until the increase and decrease personnel assignment for initial solution meets the prescribed convergence condition.

15. The personnel assignment optimization apparatus according to claims 11, wherein:
the approximation model is based on the Erlang model.
